(19) United States
(12) Patent Application Publication
(10) Pub. No.: US 2006/0209063 A1
(43) Pub. Date: Sep. 21, 2006

(54) Toboggan-based method for automatic detection and segmentation of objects in image data

(76) Inventors: Jianming Liang, Paoli, PA (US); Matthias Wolf, Exton, PA (US); Marcos Salganicoff, Philadelphia, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/247,609

(22) Filed: Oct. 11, 2005

Related U.S. Application Data
(60) Provisional application No. 60/618,008, filed on Oct. 12, 2004.
(60) Provisional application No. 60/618,009, filed on Oct. 12, 2004.

(51) Int. Cl. G06T 15/00

(52) U.S. Cl. 345/419

(57) ABSTRACT

An exemplary method of detecting one or more objects in image data is provided. The image data includes a plurality of pixels/voxels. The method includes sliding pixels/voxels that meet sliding criteria; and collecting the slid pixels/voxels that satisfy collecting criteria. An exemplary method of segmenting an object in image data is also provided. The method includes receiving an initial pixel/voxel in the image data; and forming a segmentation of the object based on the initial pixel/voxel.

### CROSS-REFERENCE TO RELATED APPLICATIONS

This application claims priority to U.S. Provisional Application No. 60/618,008, which was filed on Oct. 12, 2004, and U.S. Provisional Application No. 60/618,009 filed Oct. 12, 2004, the entire contents of both of which are fully incorporated herein by reference.

### BACKGROUND OF THE INVENTION

1. Field of the Invention

The present invention relates generally to the field of imaging, and, more particularly, to a toboggan-based method for automatic detection and segmentation of objects in images.

2. Description of the Related Art

Pulmonary embolism (“PE”) is a common and challenging diagnostic problem. PE refers a condition in which a blood clot formed in one part of the body (e.g., legs, arms) travels to the lungs and becomes detached and lodges in pulmonary arteries. Many nonfatal and fatal cases of PE are never suspected or diagnosed. Approximately 60% to 80% of the fatal PE cases are clinically unsuspected, and the patients generally die untreated.

Recently, computed tomography angiography (“CTA”) has emerged as an accurate diagnostic tool for PE. Referring now to FIGS. 1 and 2, in the CTA modality, an embolus appears as the dark region within enhanced pulmonary arteries (the lighter regions). FIG. 1 shows three different orthogonal views of a PE in computed tomography angiography. FIG. 2 shows a zoomed-in view of the same PE of FIG. 1. The cross-hairs in FIGS. 1 and 2 mark the location of the PE.

Generally, CTA images contain hundreds of CT slices in each CTA study. Therefore, manual reading of the data is laborious and time consuming. Further, such manual reading may be complicated by various PE look-alikes (i.e., false positives) including respiratory motion artifact, flow-related artifact, streak artifact, partial volume artifact, stair step artifact, lymph nodes, vascular bifurcation among many others. Even with the aid of automatic PE detection tools, it is nearly impossible for a medical professional (e.g., a radiologist) to detect and delineate all the PEs case-by-case. Therefore, it is desirable if the PEs can be automatically detected and segmented from the CTA images and visualized for assisting the medical professional in diagnosis.

### SUMMARY OF THE INVENTION

In a first aspect of the present invention a method of detecting one or more objects in image data is provided. The image data includes a plurality of pixels/voxels. The method includes the steps of sliding pixels/voxels that meet sliding criteria; and collecting the slid pixels/voxels that satisfy collecting criteria.

In a second aspect of the present invention, a machine-readable medium having instructions stored thereon for execution by a processor to perform a method of detecting one or more objects in image data is provided. The image data includes a plurality of pixels/voxels. The method includes the steps of sliding pixels/voxels that meet sliding criteria; and collecting the slid pixels/voxels that satisfy collecting criteria.

In third aspect of the present invention, a method of detecting or segmenting a pulmonary embolism in computed tomography angiography (CTA) image data is provided. The image data includes a plurality of pixels/voxels. The method includes the step of sliding pixels/voxels based on an extreme property. The pixels/voxels (a) are within a region of interest and (b) have intensity values within possible intensity values of the pulmonary embolism. The region of interest comprises one of lung fields, pulmonary vessels, or pulmonary arteries. The method further includes the step of collecting the slid pixels/voxels whose concentration locations are (a) within the region of interest, and (b) have intensity values within the possible intensity values of the pulmonary embolism.

In a fourth aspect of the present invention, a method of segmenting an object in image data is provided. The image data includes a plurality of pixels/voxels. The method includes receiving an initial pixel/voxel in the image data; and forming a segmentation of the object based on the initial pixel/voxel.

In a fifth aspect of the present invention, a machine-readable medium having instructions stored thereon for execution by a processor to perform a method of segmenting an object in image data is provided. The image data includes a plurality of pixels/voxels. The method includes the steps of receiving an initial pixel/voxel in the image data; and forming a segmentation of the object based on the initial pixel/voxel.

In a sixth aspect of the present invention, a method of detecting objects in image data is provided. The image data comprising a plurality of pixels/voxels. The method includes (a) forming a segmentation of the object based on the initial pixel/voxel; and (b) forming a detection location based on the segmentation; wherein the steps of (a) and (b) are performed for each pixel/voxel in the image data as an initial pixel/voxel.

### BRIEF DESCRIPTION OF THE DRAWINGS

The invention may be understood by reference to the following description taken in conjunction with the accompanying drawings, in which like reference numerals identify like elements, and in which:

FIG. 1 depicts an exemplary computed tomography angiography (CTA) image data with a pulmonary embolism indicated by a crosshair;

FIG. 2 depicts a zoomed-in view of the PE of FIG. 1;

FIG. 3 depicts a graphical diagram of a tobogganing process, in accordance with one exemplary embodiment of the present invention;

FIG. 4 depicts a graphical diagram of a dynamic fast tobogganing process, in accordance with one exemplary embodiment of the present invention;

FIG. 5 depicts a graphical table illustrating a two-dimensional artificial image, in accordance with one exemplary embodiment of the present invention;

FIG. 6 depicts the graphical table of FIG. 5 illustrating a grouping of pixels with different intensity values, in accordance with one exemplary embodiment of the present invention;

FIG. 7 depicts the graphical table of FIG. 6 after a tobogganing process, in accordance with one exemplary embodiment of the present invention;

FIG. 8 depicts a flow diagram illustrating a method of detecting one or more objects in image data, in accordance with one exemplary embodiment of the present invention;

FIG. 9 depicts the graphical table of FIG. 6, illustrating a portion of the ROI-based tobogganing with restricted potential method (“ROIBTWRP”), in accordance with one exemplary embodiment of the present invention;

FIG. 10 depicts a graphical table illustrating another portion of the ROIBTWRP method, in accordance with one exemplary embodiment of the present invention;

FIG. 11 depicts the graphical table of FIG. 9, illustrating yet another portion of the ROIBFTWRP method, in accordance with one exemplary embodiment of the present invention;

FIG. 12 depicts a the graphical table of FIG. 11 illustrating a result of the ROIBFTWRP method, in accordance with one exemplary embodiment of the present invention;

FIG. 13 depicts the pulmonary embolism detected and segmented in the exemplary computed tomography angiography (CTA) image data of FIG. 1, in accordance with one exemplary embodiment of the present invention; and

FIG. 14 depicts a zoomed-in view of the detected pulmonary embolism in FIG. 13, in accordance with one exemplary embodiment of the present invention; and

FIG. 15 depicts a flow diagram of the ROIBFTWRP method applied to FIG. 10, in accordance with one exemplary embodiment of the present invention.

### DETAILED DESCRIPTION OF PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

We introduce toboggan-based methods for detecting and segmenting (i.e., delineating) pulmonary embolism in contrast-enhanced CTA images. It should be appreciated that the segmentation of pulmonary embolisms in contrast-enhanced CTA images is only exemplary. Any of a variety of objects may be segmented from any of a variety of image data, as contemplated by those skilled in the art. It should be further be appreciated that the exemplary methods described herein are applicable to images of multiple dimensions and may be obtained from different modalities. Examples of different modalities include ultrasound (“US”), magnetic resonance (“MR”), X-ray, CT, single photon emission computed tomography (“SPECT”) and positron emission tomography (“PET”). Examples of multiple dimensions are two-dimensions (“2D”), three-dimensions (“3D”), four-dimensions (“4D”) and the like.

Tobogganing

Tobogganing is a method for associating a pixel/voxel with a slide direction and a concentration location. Tobogganing was first introduced as a non-iterative, single-parameter, linear execution time, over-segmentation method. It is non-iterative because it processes each image pixel/voxel only once, thereby accounting for linear execution time. The sole input defined in a traditional toboggan method is an image's “discontinuity” or “local contrast” measure, which is used to determine a slide direction at each pixel/voxel. However, such a measure does not work in the context of PE detection from CTA image data. We introduce a general concept: toboggan potential for determining a slide direction at each pixel.

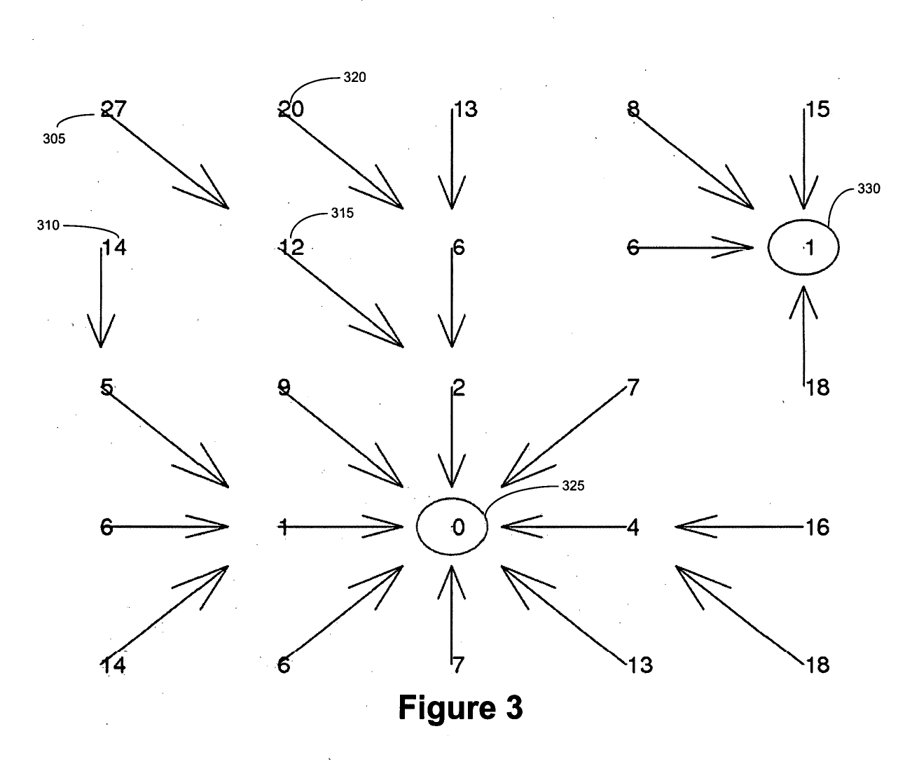

Referring now to FIG. 3, an exemplary 5×5 2D toboggan potential map is shown, in which each pixel slides to its neighbor with minimal potential, resulting in two toboggan clusters with two concentration locations. It should be appreciated that tobogganing may be used for images of any of a variety of dimensions, as contemplated by those skilled in the art.

Each number in the map represents a toboggan potential value at that pixel. The toboggan potential at a pixel is a value that can be used to determine the sliding direction at the pixel. This toboggan potential value may be calculated by processing the source image data using any number of means including, but not limited to, smoothing a gradient magnitude map of the source image with a Gaussian filter, or other smoothing filter, and calculation of a distance map with a distance transform. In some applications however, the toboggan potential can be the original image or at least one or more volumes within the original image without any processing. These volumes may be further partitioned into one or more sub-volumes. The analysis methods described herein remain predominately the same whether they are done for an entire image, a volume, or a sub-volume; thus, one of ordinary skill in the art would be able to modify the methods and apparatus described herein to work with any of these.

Toboggan potential may be used to determine a slide direction at each pixel/voxel, and may be applied to object segmentation and shape characterization. Each pixel is said to “slide” to its immediate neighbor with the lowest potential. Each arrow originates at a pixel indicates this slide direction for the pixel. For example, consider the pixel 305 with a potential of 27 in the upper left corner of the map. The immediate neighbors of the pixel 305 are pixels 310, 315 and 320, each having potentials of 14, 12 and 20, respectively. As 12 is the lowest value, the arrow emanating from the pixel 305 points to the pixel 315 with a potential of 12. In cases where the pixel is surrounded by more than one pixel that has the same minimal potential, the first pixel found with this value can be chosen or other strategies may be used in selecting a neighbor. In the case where the lowest potential around a pixel has the same value as the pixel itself, the pixel does not slide anywhere and no arrow is drawn. The different locations that the pixels slide to are called concentration locations. In this example, all the pixels generally slide to the two concentration locations—the pixel 325 with a potential of 0 and the pixel 330 with a potential of 1—each forming a single toboggan cluster. Generally, all pixels/voxels that “slide” to the same location are grouped together, thereby portioning the image volume into a collection of pixel/voxel clusters known as toboggan clusters.

We now describe a novel method called ROI-based tobogganing with restricted potential (“ROIBTWRP”) in the context of automation pulmonary embolism detection, and, in particular, with respect to CTA images.

Fast Tobogganing

As shown in FIG. 3, the traditional toboggan method generally requires scanning the entire toboggan potential to determine the sliding direction and the toboggan clusters. However, we may have prior knowledge about the location of the object to be segmented, thereby eliminating the need to scan the entire image. The location may be automatically detected, in a manner known to one skilled in the art, or manually selected by a user (e.g., clicking on the object using a mouse).

To incorporate this prior knowledge of the object location and to improve the efficiency of the traditional toboggan method, a dynamic fast toboggan method has been developed. The fast toboggan method starts from a specified location and quickly forms a toboggan cluster locally without involving any pixels/voxels beyond the outer boundary of the toboggan cluster. The fast toboggan method generates one cluster from a starting location and dynamically computes the potential of the cluster only when necessary.

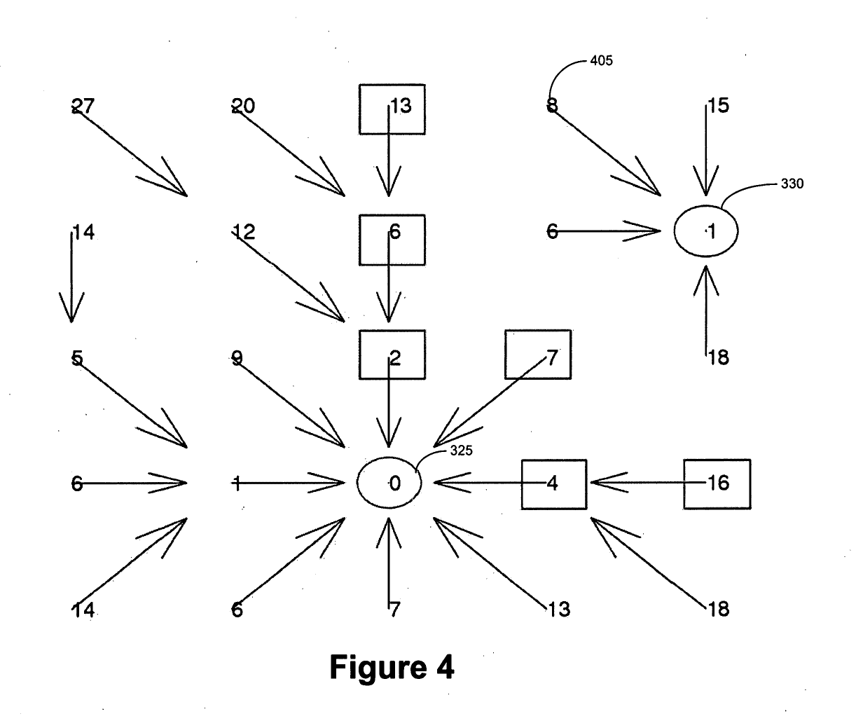

Referring now to FIG. 4, the exemplary 5×5 2D toboggan potential map of FIG. 3 is shown illustrating the dynamic fast tobogganing process. In this particular example, the potential is given; thus, there is no need to dynamically compute the potential. If a pixel (4,1) 405 with potential 8 is selected as an initial site, the cluster 330 concentrated on (5,2) with potential 1 will be formed, involving no more pixels than those in the clusters 330 and those at its outer boundary (indicated with rectangles). The remainder of the pixels are left untouched, leading to a high efficiency.

Regions of Interest-Based Tobogganing with Restricted Potential

Furthermore, we may also know the intensity values of the objects (e.g., the CT values in the case of CTA image data). The fast tobogganing method can be restricted to only those pixels/voxels with certain intensity values. The intensity values may be specified as a single intensity range (i.e., between a low threshold and a high threshold) or multiple intensity ranges. By restricting the tobogganing method to a particular ROI and pixels/voxels with certain criteria (for instance, intensity values of the pixel, or a function of the pixel/voxel and possibly nearby pixels/voxels), we can significantly improve the efficiency of the tobogganing process, especially for large image volume data. We call this type of tobogganing ROI-based tobogganing with restricted potential (“ROIBTWRP”).

An exemplary embodiment of the ROIBTWRP method is discussed in greater detail below. Although not so limited, we describe ROI-based tobogganing with restricted potential in the context of automation pulmonary embolism detection, and, in particular, with respect to CTA images. However, it should be appreciated that ROI-based tobogganing with restricted potential extends beyond the presented context to any of a variety of images from different modalities of any dimensions, as contemplated by those skilled in the art.

An Exemplary ROIBTWRP Method

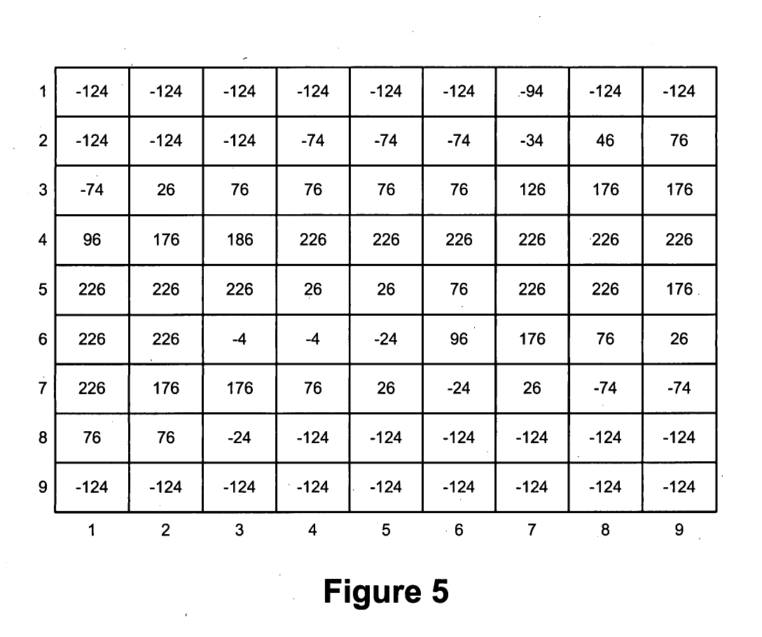

Referring now to FIG. 5, an exemplary table of CT value entries of various pixels/voxels in an artificial CTA image is shown. The artificial image is created to resemble a small artery with pulmonary embolism. In FIG. 5, the intensity value of the PE is within the intensity range of −50HU and 100HU, in a 2D view surrounded by blood with contrast agent (with intensity range greater than 100 HU). For illustrative purposes, no mask is applied in this example.

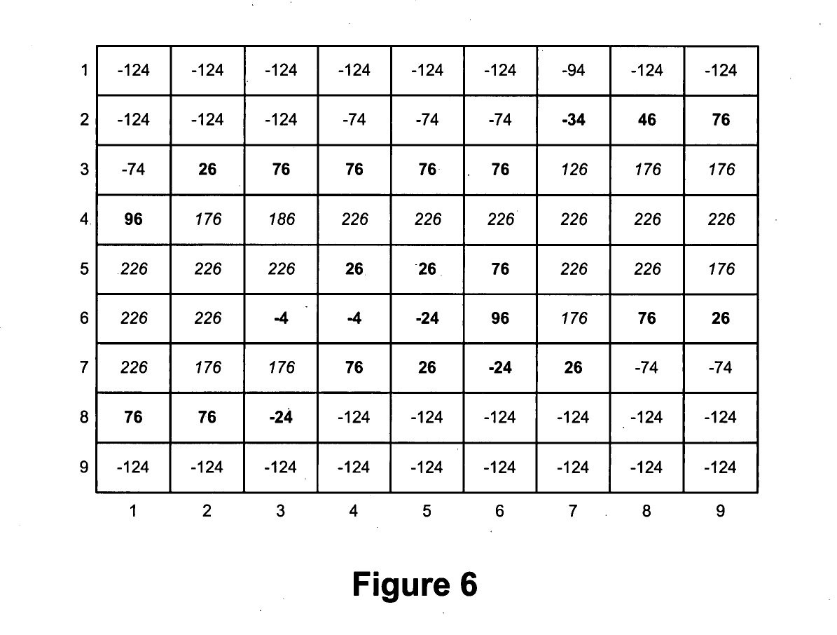

Referring now to FIG. 6, the exemplary table of FIG. 5 is shown after grouping the pixels with respect to their intensity ranges. In CTA images, PE pixels/voxels have CT values within a range in terms of Hounsfield Unit (“HU”) (e.g., between −50 HU and 100 HU). Consider, for example, using this HU range as a simple threshold. The CT values below −50 are in normal text, the CT values above 100 are italicized, and the CT values within the HU range are bolded. The problem here is that the values in the HU range also show non-PE pixels/voxels, due to partial volume effects around the vessel wall and around the air-filled tissue wall. That is, the simple threshold may include many pixels/voxels that are not PE but within the intensity range (i.e., the HU range). Therefore, for automatic pulmonary embolism detection, it is critical to remove the pixels/voxels around the vessel boundaries and around the air-filled tissue boundaries.

The, ROIBTWRP method described herein can effectively keep the PE pixels/voxels while efficiently removing pixels/voxels that are within the HU range but around the vessel boundaries and the air-filled tissue. Furthermore, pulmonary embolism can exist only in pulmonary arteries. Therefore, we can use a mask to restrict the tobogganing process within a small region. The mask can be, for example, a lung mask including the entire lung area, a vessel mask covering all the pulmonary vessels, or an artery mask covering the arteries only. In the extreme situation when the mask covers the entire image data, ROIBTWRP essentially becomes tobogganing with no mask.

Similarly, when the potential range covers the whole spectrum of the potential values, ROIBTWRP becomes tobogganing with no potential restrictions.

An Illustrative Detection Example

We now describe an exemplary embodiment of the ROIBTWRP method step-by-step by examining a two-dimensional (“2D”) artificially-created image. The exemplary 2D image is small and is intended illustrative purposes only. We assume knowledge of the ROI; therefore, no mask is applied in this illustration. In summary, the steps of ROIBTWRP are generally as follows: (a) slide each pixel/voxel in the range of [−50HU 100HU] to its neighbor with smallest intensity, and (b) collect the pixels/voxels which are not merged in the region and are less than −50 HU. The collected pixels/voxels in step (b) are considered the detected PE.

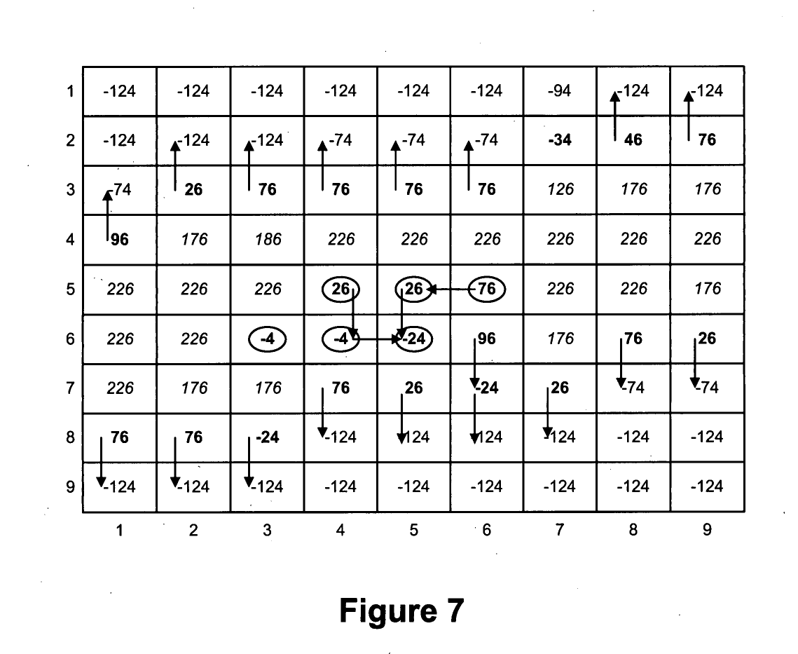

Referring now to FIG. 7, the exemplary table of FIG. 6 is shown, illustrating the collection of all pixels/voxels that do not slide (i.e., toboggan) into the artery boundaries or the air-filled tissue boundaries (i.e., dark regions). As a result, there is no need to label the pixels/voxels and no need to maintain sliding directions of the pixels/voxels as in the traditional toboggan methods. This yields further efficiency over the traditional toboggan method, in addition to the gains in efficiency from limiting the tobogganing method to the ROI and pixels/voxels with certain intensity thresholds.

To remove the pixels around the artery boundaries, we let all the pixels with CT values between −50HU and 100HU toboggan (i.e., slide) to its neighbor with minimal CT value. A 2D four-connected neighborhood is used in FIG. 7, but other types of neighborhood connectivity can be used. The pixels around the arteries will merge into vessel boundaries (i.e., the areas with lower CT values), and also for the pixels around the air-filled tissue (not shown).

We collect all the pixels that do not slide into vessel boundaries or the air-filled tissue boundaries and consider these pixels as PE candidates. In this example, all the PE 5 candidate pixels are circled. The pixel (3,6) is a single-pixel toboggan cluster, while other pixels form one cluster with its concentration at pixel (5,6).

A natural question then arises: whether we should include pixel (6,6) as a PE pixel. For PE detection, it is not so critical to look into an individual pixel. If we want to have individual pixels like (6,6), we can collect them based on the sliding distance and their adjacency to existing PE candidates, among other criteria. Furthermore, a connected component analysis can be applied to connect the PE candidate pixels into pixel groups, if desired.

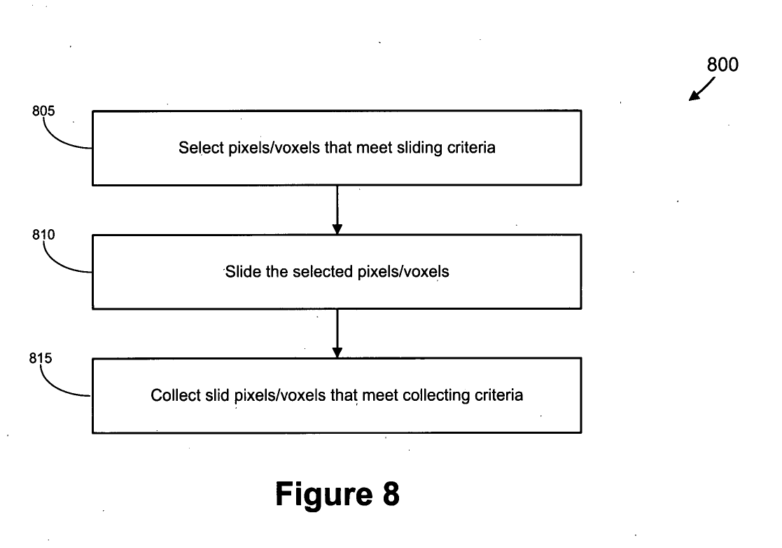

Referring now to FIG. 8, a flow diagram 800 illustrating an exemplary method of detecting one or more objects in image data is shown. For example, the image data may be a computed tomography angiography (“CTA”) image data. Further, the object to be detected may be a pulmonary embolism. The image data generally includes a plurality of pixels/voxels. Pixels/voxels that meet sliding criteria are selected (at 805). The sliding criteria may include restrictions that the pixels/voxels be in the region of interest and have intensity values within the intensity range, as described in greater detail above. For example, the region of interest for detecting pulmonary embolism may be the pulmonary arteries, and the intensity range for detecting pulmonary embolism may be all possible intensity values for the pulmonary embolism.

The selected pixels/voxels are slid (at 810). For example, the selected pixels/voxels may be slid towards a concentration location based on an extreme property. The extreme property may include a minimum or maximum potential of the neighbors, or a minimum or maximum slope between the sliding pixel/voxel and the neighbor. It should be appreciated that the step of selecting (at 805) may be integrated into the step of sliding (at 810). The slid pixels/voxels that satisfy collecting criteria are collected (at 815). The collecting criteria may include restrictions for collecting only those pixels/voxels whose concentration locations are in the region of interest and have intensity values within the intensity range.

An Illustrative Segmentation Example

When an initial site is available, the popular approach for object segmentation is region/volume growing. In the case of segmentation of PE, the region/volume growing approach can easily leak in the vessel boundaries and grow out of control. Therefore, for pulmonary embolism segmentation, it is desirable to exclude the pixels/voxels around the vessel boundaries and around the air-filled tissue boundaries (i.e., include the pixels/voxels except those pixels/voxels around the vessel boundaries and around the air-filled tissue boundaries). The exemplary ROIBTWRP method described herein can efficiently include the PE pixels/voxels without those around the vessel boundaries and the air-filled boundaries.

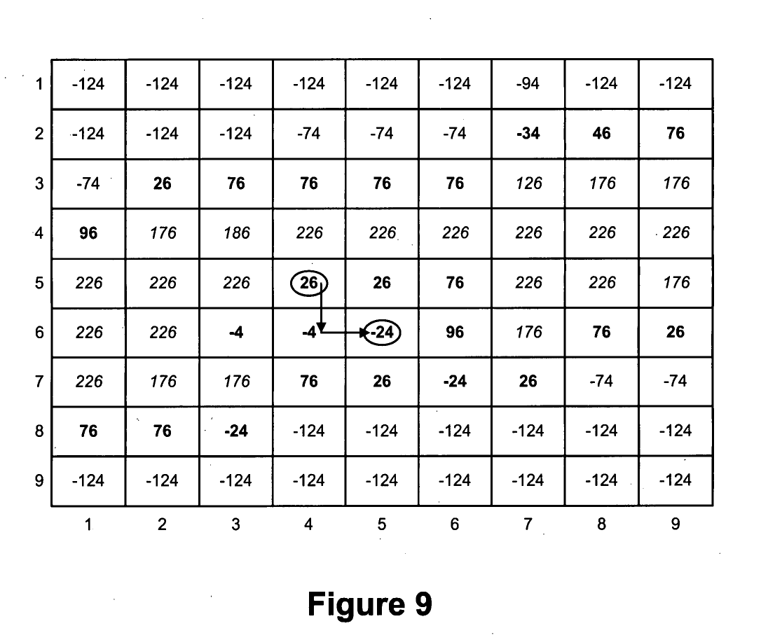

With reference to FIG. 9 to FIG. 12, we now illustrate the ROIBTWRP method step-by-step by examining a 2D artificial image (i.e., a man-made image). The exemplary 2D image is small and intended only for illustrative purposes. The grayscale is coded by a value. The higher the value, the brighter the appearance of the pixel in the image.

In ROIBTWRP, to segment PE, we generally need to collect only the pixels/voxels that do not slide (i.e., toboggan) into the artery boundaries or the air-filled tissue boundaries (i.e., the dark regions). As a result, we only need to label a pixel/voxel as PE or nonPE. There is generally no need to maintain sliding directions of the pixels/voxels, as in the traditional toboggan method. This yields further efficiency over the traditional toboggan method, in addition to the gains in efficiency from limiting the tobogganing method to the region of interest (“ROI”) and pixels/voxels with certain intensity thresholds.

Solely for purposes of illustration, the sliding directions are shown in the FIGS. 9 to 12. Thus, the distinguished toboggan labels can be easily derived. It should be noted that there is no need to use the information of toboggan labels and directions for the purpose of PE segmentation.

Referring now to FIG. 9, we consider that the user clicks pixel (4,5) with intensity value of 26 HU (circled); we want to find all the PE pixels/voxels. FIG. 9 illustrates the first phase of the fast toboggan method, which is to find the concentration location. To find the concentration location, we regard the starting location as the current location, slide the starting location to its neighbor with minimal potential, select the neighbor as the current location, and slide the neighbor until reaching the concentration location—a location that cannot slide to any of its neighbors. In this particular example, pixel (4,5) slides to pixel (4,6) and then pixel (4,6) slides to pixel (5,6), reaching the concentration location.

It should be noted that the 2D four-connected neighborhood used in FIG. 9 is only exemplary; other types of neighborhood connectivity can be used, as contemplated by those skilled in the art. To effectively segment PE, we need to slide only those pixels/voxels with certain intensity values; there is no need to involve all the pixels/voxels. To this end, we restrict the fast toboggan only on those pixels with restricted potential. We refer to this type of fast tobogganing as ROI-based tobogganing with restricted potential (“ROIBTWRP”).

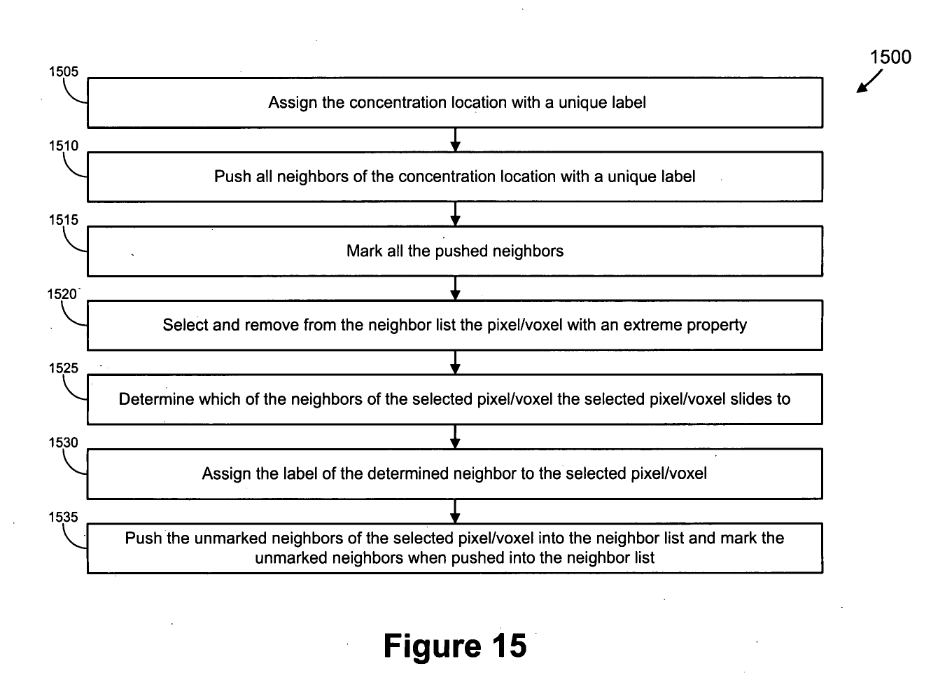

Referring now to FIG. 9, once the concentration location is found from FIG. 8, the ROIBTWRP method starts to expand from the concentration location to form a toboggan cluster. Consider the concentration location as the first expanding pixel/voxel. The steps of forming the toboggan cluster are as follows (in reference to FIG. 15):

(1) assign (at 1505) the concentration location with a unique label;

(2) push (at 1510) all the neighbors of the concentration location into a neighbor list and mark (at 1515) them (i.e., all neighbors of the concentration location) (the marking will guarantee the uniqueness of a pixel/voxel in the neighbor list)

(3) select and remove (at 1520) from the neighbor list the pixel/voxel with an extreme property;

(4) determine (at 1525) which of the neighbors of the selected pixel/voxel the selected pixel/voxel slides to;

(5) assign (at 1530) the label of the determined neighbor to the selected pixel/voxel; and

(6) push (at 1535) the unmarked neighbors of the selected pixel/voxel into the neighbor list, and mark the unmarked neighbors when pushed into the neighbor list.

We can repeat steps (3) to (6) on the pixel/voxel with an extreme property from the neighbor list until the neighbor list is empty.

It is generally desirable to restrict tobogganing on those pixels/voxels within particular intensity ranges (e.g., [−50 100] HU) and regions of interest (e.g. within the lungs, or in the arteries). That is, no pixels/voxels outside of the intensity range are included, and no pixels/voxels outside of the intensity range are explored. In FIG. 8, ROIBTWRP expands from pixel (5,6) and includes pixel (4,6), (5,5), (4,5) and (6,5), forming a toboggan cluster containing the starting location (4,5). For illustrative purposes, no regions of interest are applied in this example.

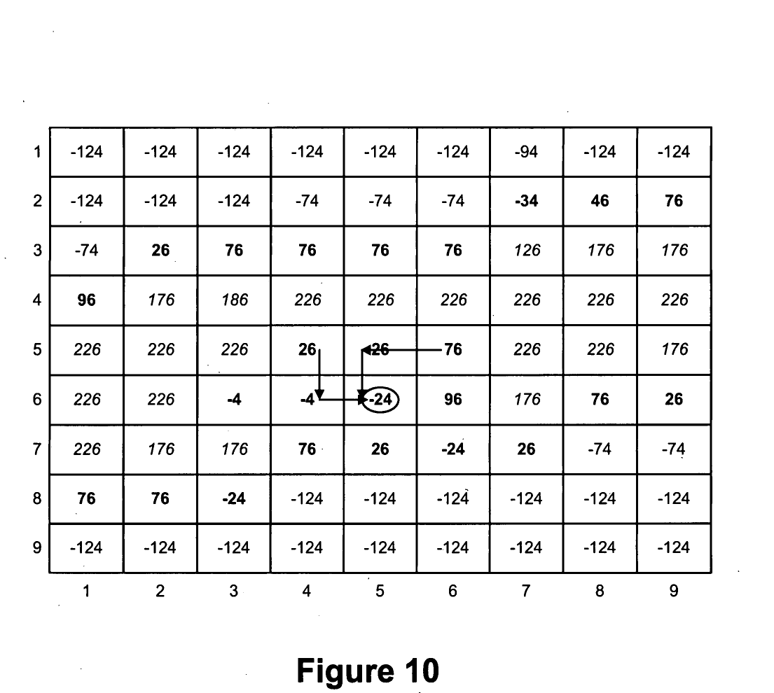

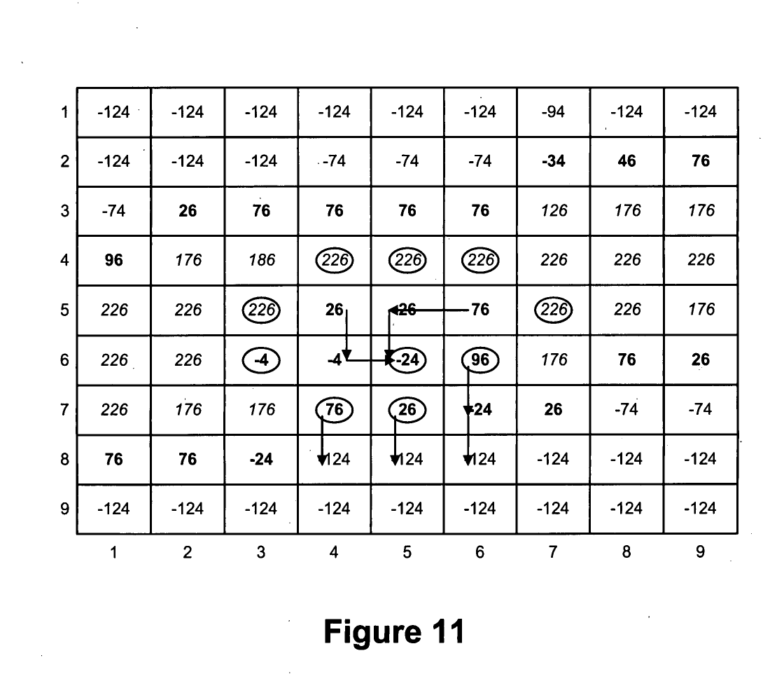

Referring now to FIG. 11, the fast toboggan expansion process involves only those pixels/voxels in the toboggan cluster and neighboring pixels of those pixels/voxels (marked with circles around pixel (5,6)). To include all the PE pixels/voxels, we repeatedly apply the fast tobogganing process on each of these neighboring pixels/voxels. That is, we regard each of these neighboring pixels/voxels as a new starting location for another fast tobogganing. This process is applied to only those pixels within the specified intensity range, and continues until no neighboring pixels/voxels are within the intensity range. In this particular example, only the neighboring pixels (3,6), (4,7), (5,7) and (6,6) can slide. All other pixels are not within the intensity range (e.g., [−50 100] HU) and no tobogganing is performed on those other pixels. Pixel (3,6) forms a single-pixel toboggan cluster, while all others pixels including pixels (4,7), (5,7) and (6,6) slide into the vessel boundaries (i.e., dark regions). The fast tobogganing is again applied to the newly obtained neighboring pixels (2,6), (3,7) (not marked in this figure) due to the formation of a single-pixel cluster at pixel (3,6). However, both of the newly obtained neighboring pixels are not within the intensity range, and, therefore, cannot slide. No neighboring pixels are left and PE segmentation process stops. All the pixels/voxels that do not slide into the vessel boundaries are collected and regarded as PE pixels/voxels, as illustrated in FIG. 10 below.

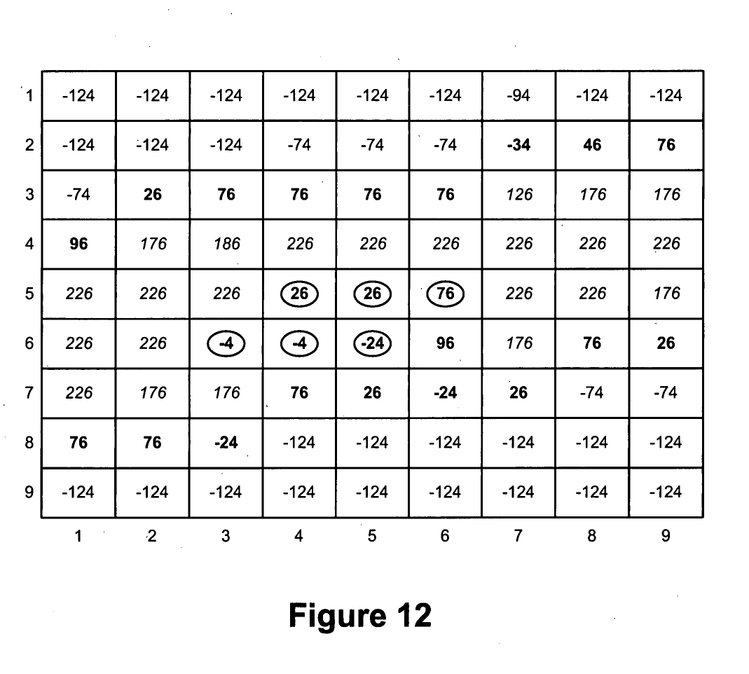

Referring now to FIG. 12, all of the collected PE pixels/voxels are circled. A natural question arises: whether pixel (6,6) should be regarded as a PE pixel. For PE segmentation, it is not so critical to look into an individual pixel. If we want to have those pixels like (6,6), we can collect them based on the sliding distance and the adjacency to existing PE pixels/voxels, among other criteria.

Segmenting Using the Toboggan-Based Method of Detection

It should be appreciated that the toboggan-based method of detection, as described herein, may be used for segmenting PEs. In one embodiment, connected component analysis is performed on collected pixels/voxels to form the segmentations of PEs.

Detecting Using the Toboggan-Based Method of Segmentation

It should be appreciated that the toboggan-based method of segmentation, as described herein, may be used for detecting PEs. In one embodiment, the toboggan-based method of segmentation is applied for each pixel/voxel in the image data as an initial pixel/voxel. In another embodiment, the toboggan-based method of segmentation is applied for each pixel/voxel in the image data as an initial pixel/voxel if each pixel/voxel is not labeled. The output of the detection may be clusters-based or position-based. Cluster-based means output the whole cluster as a candidate, while position-based means to find a point from the cluster to represent the cluster. Its concentration site may be directly used for this purpose. However, it should be appreciated that there are a number of other ways, as known to those skilled in the art, to determine a representative point for a cluster, for instance, by morphological ultimate erosion.

A Clinical Case

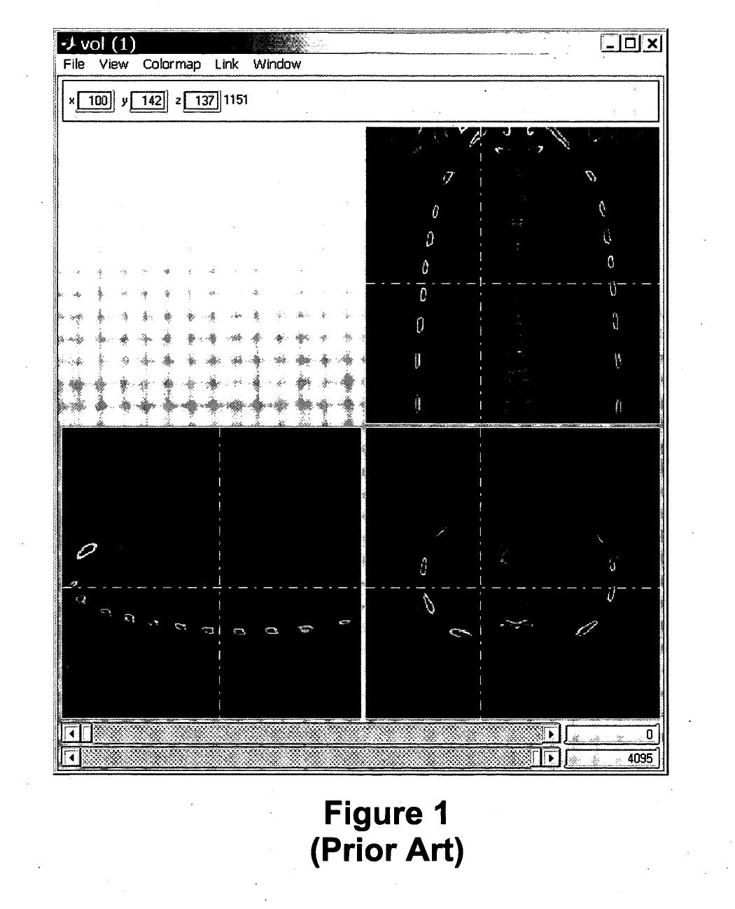

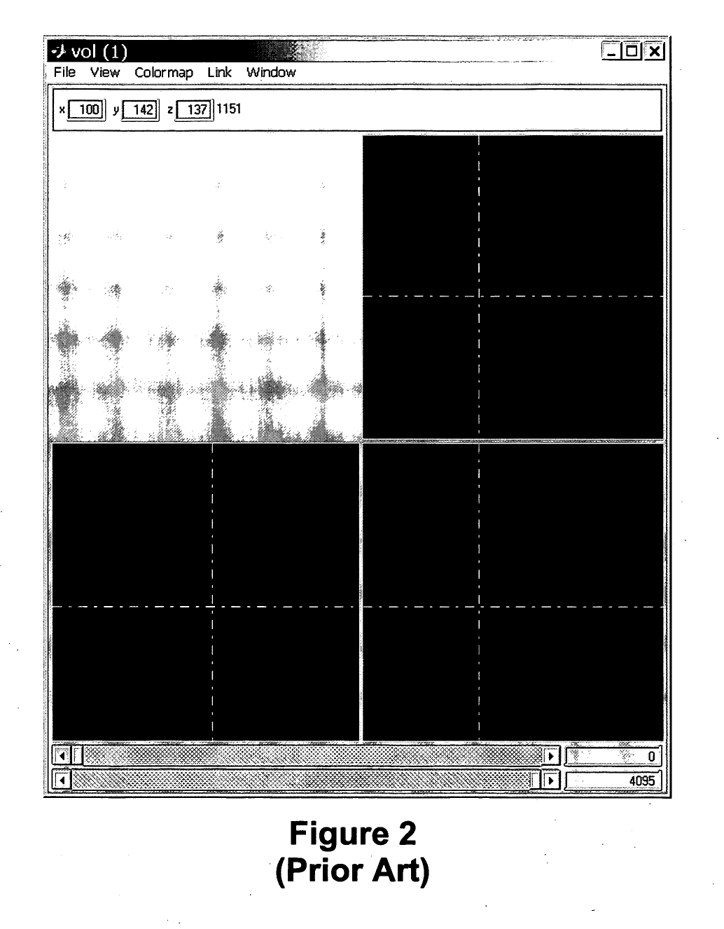

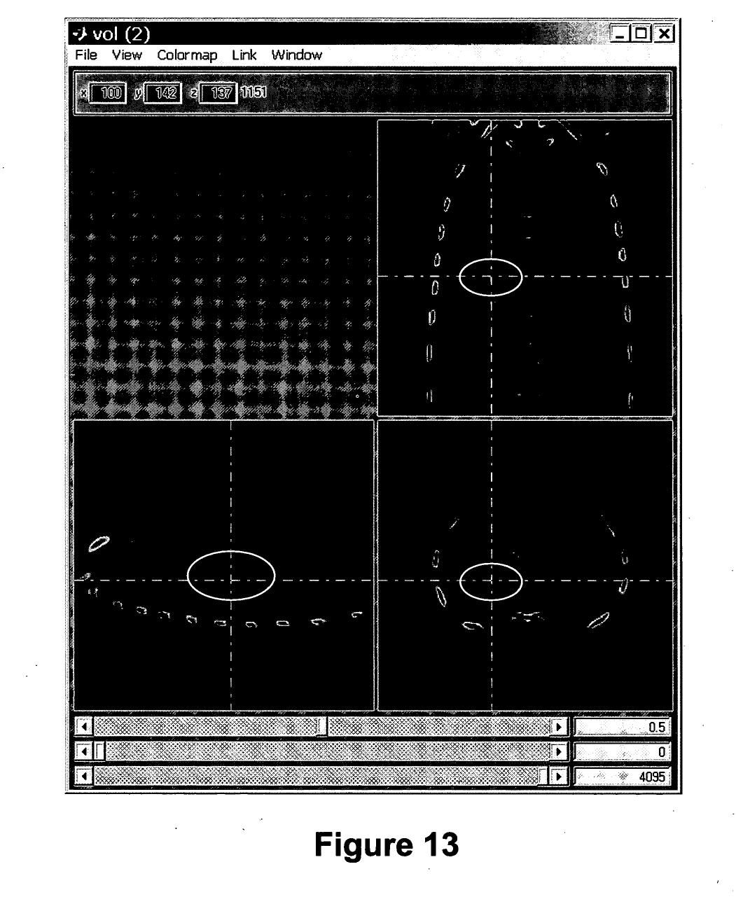

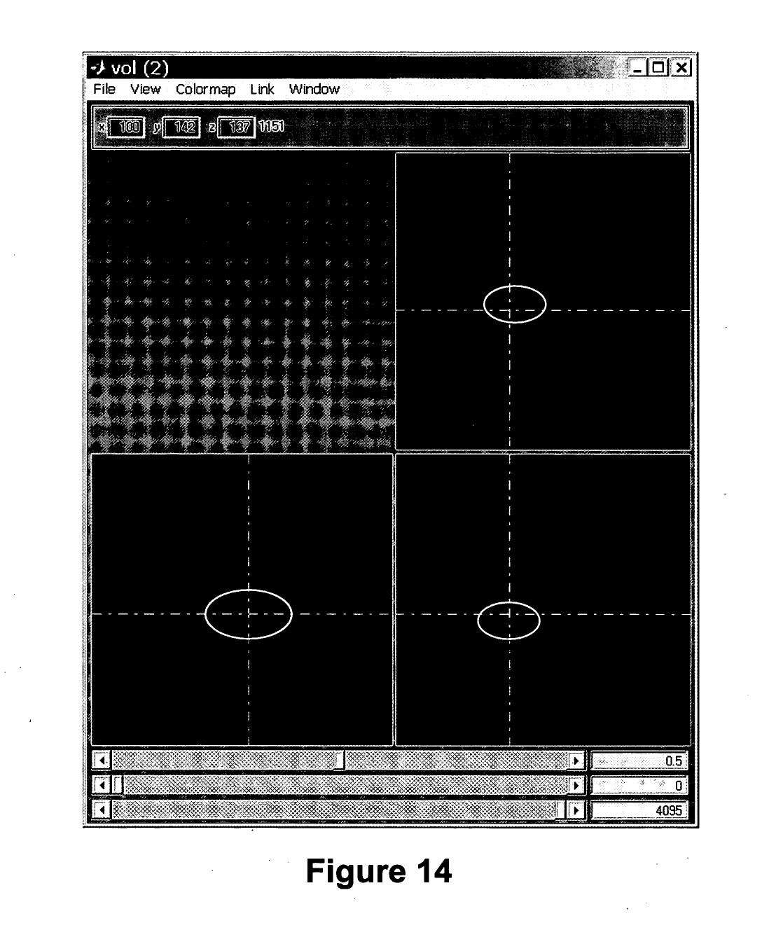

For the clinical case shown in FIG. 1, with a zoomed-in view of pulmonary embolism in FIG. 2, the segmented PE with the disclosed method is shown (circled) and superimposed on the original CTA image data FIG. 13. FIG. 14 provides a zoomed-in view of the segmented pulmonary embolism. The cross-hairs located in FIG. 13 and FIG. 14 show the location of the PE.

Summary

We have disclosed exemplary embodiments for automatic pulmonary embolism detection. The inventive method, which we refer to as ROI-based tobogganing with restricted potential, toboggans only those pixels/voxels in restricted regions and with restricted potential values for efficiency. In one exemplary embodiment, the method is described in the context of automatic detection of pulmonary embolism in CTA images data. Comparing to the traditional toboggan method, the disclosed ROIBTWRP method has additional efficiency due to no labeling and no directing.

We have also disclosed exemplary embodiments for automatic pulmonary embolism segmentation. The inventive method, ROIBTWRP, toboggans only those pixels/voxels with restricted potential values. The results in greater efficiency over traditional tobogganing methods. In one exemplary embodiment, the method is described in the context of segmenting pulmonary embolism in CTA images data. In contrast with traditional tobogganing methods, the ROIBFTWRP method processes only those pixels/voxels regarded as PE and the neighboring pixels/voxels of those pixels/voxels, resulting in a significant increase in efficiency. The disclosed method has additional efficiency due to no directing and only binary labeling (i.e., PE or nonPE).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of detecting one or more objects in image data, the image data comprising a plurality of pixels/voxels, the method comprising:
sliding pixels/voxels that meet the sliding criteria; and
collecting the slid pixels/voxels that satisfy collecting criteria.

2. The method of claim 1, wherein the one or more objects comprises a plurality of regions, and wherein at least one of the plurality of regions is a dark region at least partially surrounded by one or more light regions.

3. The method of claim 1, wherein the one or more objects comprises a plurality of regions, and wherein at least one of the plurality of regions is a light region at least partially surrounded by one or more dark regions.

4. The method of claim 1, further comprising:
computing a complement of the image data.

5. The method of claim 1, wherein the one or more objects comprises at least one of a pulmonary embolism, bone mets, hot spots, colon polyps, or lung nodules in the image data, and wherein the image data is determined through an imaging modality.

6. The method of claim 5, wherein the imaging modality comprises at least one of computed tomography (CT), CT angiography (CTA), magnetic resonance (MR), positron emission tomography (PET), or single photon emission computed tomography (SPECT).

7. The method of claim 1, wherein the step of sliding pixels/voxels that meet the sliding criteria, comprises:
sliding pixels/voxels in a region of interest.

8. The method of claim 7, wherein the region of interest comprises one of lung fields, pulmonary vessels, or pulmonary arteries.

9. The method of claim 7, wherein the region of interest comprises a region of tissues.

10. The method of claim 9, wherein the region of tissues comprises a colon wall or a bone area.

11. The method of claim 1, wherein the step of sliding pixels/voxels that meet the sliding criteria comprises:
sliding each pixel/voxel satisfying a logic criteria that is a function of the each pixel/voxel and possibly nearby pixels/voxels.

12. The method of claim 1, wherein the step of sliding each pixel/voxel satisfying a logic criteria that is a function of the pixel/voxel and possibly nearby pixels/voxels comprises:
sliding pixels/voxels with an intensity value within an intensity range.

13. The method of claim 12, wherein the intensity range comprises all possible intensities of the object to be detected.

14. The method of claim 11, wherein the intensity range is a Hounsfield Unit range.

15. The method of claim 1, wherein the step of sliding the pixel/voxels comprises:
sliding each of the pixels/voxels to one of the neighbors of the each of the pixels/voxels, wherein the one of the neighbors has an extreme property.

16. The method of claim 15, wherein the extreme property comprises one of a minimum potential, a maximum potential, a minimum slope, or a maximum slope.

17. The method of claim 1, wherein the step of sliding pixels/voxels comprises:
sliding each of pixels/voxels until a concentration location is reached.

18. The method of claim 1, wherein the step of sliding pixels/voxels comprises:
repeatedly sliding the each of the pixels/voxels to an adjacent neighbor with an extreme property until the adjacent neighbor with the extreme property does not exist.

19. The method of claim 1, wherein the step of sliding pixels/voxels comprises:
sliding each of the pixels/voxels towards a concentration location based on an extreme property.

20. The method of claim 1, wherein the step of collecting the slid pixels/voxels that satisfy collecting criteria, comprises:
collecting the slid pixels/voxels whose concentration locations have intensity values within an intensity range.

21. The method of claim 20, wherein the intensity range comprises all possible intensities of the object to be detected.

22. The method of claim 1, wherein the step of collecting the slid pixels/voxels that satisfy collecting criteria, comprises:
collecting the slid pixels/voxels whose the concentration locations are in a region of interest.

23. The method of claim 22, wherein the region of interest comprises one of lung fields, pulmonary vessels, or pulmonary arteries.

24. The method of claim 22, wherein the region of interest comprises one of the colon wall, a bone area, or a region of other organs.

25. The method of claim 1, further comprising:
performing connected component analysis on the collected pixels/voxels.

26. The method of claim 25, further comprising:
forming detection locations based on the connected component analysis.

27. A machine-readable medium having instructions stored thereon for execution by a processor to perform a method of detecting one or more objects in image data, the image data comprising a plurality of pixels/voxels, the method comprising:
sliding pixels/voxels that meet sliding criteria; and
collecting the slid pixels/voxels that satisfy collecting criteria.

28. A method of segmenting an object in image data, the image data comprising a plurality of pixels/voxels, the method comprising:
receiving an initial pixel/voxel in the image data; and
forming a segmentation of the object based on the initial pixel/voxel.

29. The method of claim 28, wherein the object comprises at least one of a pulmonary embolism, bone mets, hot spots, colon polyps, or lung nodules in the image data, and wherein the image data is determined through an imaging modality.

30. The method of claim 28, wherein the imaging modality comprises at least one of computed tomography (CT), CT angiography (CTA), magnetic resonance (MR), or positron emission tomography (PET), or single photon emission computed tomography (SPECT).

31. The method of claim 28, wherein the step of receiving an initial pixel/voxel in the image data comprises automatically determining the initial pixel/voxel in the image data.

32. The method of claim 28, wherein the step of receiving an initial pixel/voxel in the image data comprises receiving a user-selected pixel/voxel.

33. The method of claim 28, wherein the step of forming a segmentation of the object based on the initial pixel/voxel comprises:
sliding the initial pixel/voxel until a concentration location is reached;
forming a toboggan cluster starting from the concentration location;
forming additional toboggan clusters based on neighboring pixels/voxels of the formed toboggan clusters.

34. The method of claim 33, wherein the step of sliding the initial pixel/voxel until a concentration location is reached comprises:
sliding the initial pixel/voxel to a neighbor with an extreme property until the concentration location is reached.

35. The method of claim 34, wherein the extreme property comprises one of minimal potential, maximal potential, minimum slope, or maximum slope.

36. The method of claim 33, wherein the step of forming a toboggan cluster starting from the concentration location comprises:
(a) assign the concentration location with a unique label;
(b) pushing all the neighbors of the concentration location into a neighbor list and marking all neighbors of the concentration location;
(c) selecting and removing from the neighbor list a pixel/voxel with an extreme property;
(d) determining which of the neighbors of the selected pixel/voxel the selected pixel/voxel slides to;
(e) assigning the label of the determined neighbor to the selected pixel/voxel; and
(f) pushing unmarked neighbors of the selected pixel/voxel into the neighbor list and marking the unmarked neighbors of the selected pixel/voxel.

37. The method of claim 36, further comprising the step of:
(g) repeating steps (c) to (f) until the neighbor list is empty.

38. The method of claim 36, wherein the extreme property comprises one of minimal potential, maximal potential, minimum slope, or maximum slope.

39. The method of claim 33, wherein the step of forming additional toboggan clusters based on neighboring pixels/voxels of the formed toboggan cluster comprises:
sliding the neighboring pixels/voxels that are within an intensity range until corresponding concentration locations are reached; and
forming neighboring toboggan clusters starting from the corresponding concentration locations.

40. The method of claim 33, further comprising the step of:
collecting object pixels/voxels that do not slide into pixels/voxels outside of intensity ranges.

41. The method of claim 40, wherein the intensity ranges comprises all possible intensities of the object to be detected.

42. The method of claim 40, wherein the intensity range is a Hounsfield Unit range.

43. The method of claim 42, wherein the intensity range comprises [−50 100] HU.

44. The method of claim 28, wherein the object comprises a light region surrounded by a one or more dark regions.

45. The method of claim 28, wherein the object comprises a dark region surrounded by one or more light regions.

46. The method of claim 28, further comprising:
computing a complement of the image data.

47. A machine-readable medium having instructions stored thereon for execution by a processor to perform a method of segmenting an object in image data, the image data comprising a plurality of pixels/voxels, the method comprising the steps of:
receiving an initial pixel/voxel in the image data; and
forming a segmentation of the object based on the initial pixel/voxel.

48. A method of detecting objects in image data, the image data comprising a plurality of pixels/voxels, the method comprising:
(a) forming a segmentation of the object based on an initial pixel/voxel, and
(b) forming a detection location based on the segmentation,
wherein the steps of (a) and (b) are performed for each pixel/voxel in the image data as the initial pixel/voxel.

49. The method of claim 48, wherein the step of forming a detection location based on the segmentation, comprises:
performing morphological ultimate erosion.

50. The method of claim 48, wherein the step of forming a segmentation of the object based on an initial pixel/voxel, comprises:
forming a segmentation of the object based on an unlabeled initial pixel/voxel.

51. A method of segmenting one or more objects in image data, the image data comprising a plurality of pixels/voxels, the method comprising:
sliding pixels/voxels that meet the sliding criteria;
collecting the slid pixels/voxels that satisfy collecting criteria; and
performing connected component analysis on the collected pixels/voxels to form a segmentation of the one or more objects.
